(19) United States
(12) Patent Application Publication
(10) Pub. No.: US 2005/0191515 A1
(43) Pub. Date: Sep. 1, 2005

(54) Very low thermal expansion composite

(75) Inventors: Nathaniel Eric Brese, Farmingdale, NY (US); Garo Khanarian, Princeton, NJ (US); Craig Stewart Allen, Shrewsbury, MA (US)

Correspondence Address: S. Matthew Cairns;Edwards & Angell, LLP, P.O. Box 55874, Boston, MA, 02205, US

(73) Assignee: Shipley Company, L.L.C., Marlborough, MA (US)

(21) Appl. No.: 11/113,680

(22) Filed: Apr. 25, 2005

Related U.S. Application Data
(62) Division of application No. 09/619,795, filed on Jul. 20, 2000.

(51) Int. Cl. B32B 15/02

(52) U.S. Cl. 428/633; 428/632

(57) ABSTRACT

Disclosed are composites having very low coefficients of thermal expansion and methods of preparing the composites. Also disclosed are composites having negative coefficients of thermal expansion. Applications of the composites to a wide variety of uses, such as electronic and optoelectronic devices are also disclosed.

### BACKGROUND OF INVENTION

In general, this invention pertains to negative thermal expansion materials, methods of making the materials, composites made therefrom, and devices made therefrom. More particularly, the present invention relates to composites which have very low thermal expansion.

The vast majority of materials expand on heating, i.e., they have positive coefficients of thermal expansion (“PTE”). Such materials, however, expand on heating at widely different rates. These differences in expansion can cause a variety of problems in electronic and optoelectronic applications. For example, strains induced by expansion and contraction can result in delamination of layers, such as in printed wiring boards, or cracking of connections. In optoelectronic applications, movement induced by expansion results in misalignment of optical connections and temporary or permanent device failure.

A coefficient of thermal expansion (“CTE”) also results in the decrease of the refractive index of a material with increasing temperature. In certain classes of optoelectronic devices this can cause the device not to operate.

There are unusual materials which contract in all three dimensions when heated, that is they have an isotropic negative thermal expansion coefficient (“NTE”). A particularly useful class of such materials is described in U.S. Pat. Nos. 5,433,778; 5,514,360 and 5,919,720 (all assigned to Oregon State University). These patents disclose (Zr,Hf)W₂O₈ and similar compounds. U.S. Pat. No. 5,488,018 (Limaye) describes a similar material in the (Sr,Ba)—(Zr,Hf)—P—Si—O system. All the above patents describe the use of high temperature processing techniques which result in large particles (generally >1 micron) which produce inhomogeneous composites. Inhomogeneous mixing of PTE and NTE materials leads to large domains with dissimilar responses to temperature and ultimately to stress, cracking and device failure.

In theory, materials with positive and negative coefficients of thermal expansion can be mixed in appropriate portions to form a bulk matrix or composite with zero thermal expansion. The problems in fabricating such composites are that homogeneous mixing of powdered materials is difficult to achieve and the sintering of such composites, which is typically required, can lead to reaction of the two materials. For example, published PCT patent application WO 99/64898 discloses ceramic bodies containing A₂P₂WO₁₂ and a glassy phase which has negative thermal expansion for use in temperature-compensated optical fiber gratings. The process disclosed in this patent application involves high temperature sintering and results in inhomogenous composites containing glassy materials.

There is thus a need for composites having very low coefficients of thermal expansion. It is desired to provide such composites in a homogenous fashion without compounding of dry powders. It is also desired to make nanometer-sized particles of NTE materials, which could be blended more homogeneously with polymeric materials at more moderate temperatures than those available presently.

### SUMMARY OF THE INVENTION

It has been surprisingly found that composites having very low coefficients of thermal expansion may be prepared by generating particles of materials with positive coefficients of thermal expansion and negative coefficients of thermal expansion simultaneously, rather than compounding and sintering such materials prepared separately. It has been further surprisingly found that such composites are substantially homogeneous.

In one aspect, the present invention provides a method for depositing composites having very low coefficients of thermal expansion on a substrate including the steps of a) providing a first solution including one or more zirconium compounds in a solvent; b) providing a second solution including one or more tungsten compounds in a solvent; c) simultaneously vaporizing the first and second solutions; d) depositing on the surface of the substrate a composite having a very low coefficient of thermal expansion by spray pyrolysis or combustion chemical vapor deposition; wherein the composite is substantially homogeneous.

In a second aspect, the present invention provides composites having very low coefficients of thermal expansion wherein the composites include substantially homogeneous mixtures of one or more negative coefficient of thermal expansion materials and one or more positive coefficient of thermal expansion materials.

In a third aspect, the present invention provides a device including one or more composites having very low coefficients of thermal expansion.

In a fourth aspect, the present invention provides a method for preparing a composite having intimately-mixed particles of materials, the composite having very low coefficients of thermal expansion including the steps of a) providing a first solution including one or more zirconium compounds in a solvent; b) providing a second solution including one or more tungsten compounds in a solvent; c) simultaneously combusting the first and second solutions to form vapor phase composite particles; and d) isolating the composite particles; wherein the composite particles are substantially homogeneous.

In a fifth aspect, the present invention provides a method for preparing particles of materials having negative coefficients of thermal expansion including the steps of a) providing a solution including one or more zirconium compounds and one or more tungsten compounds in a solvent; b) vaporizing the solution to form vapor phase particles; and d) isolating the particles.

### DETAILED DESCRIPTION OF INVENTION

As used throughout this specification, the following abbreviations shall have the following meanings, unless the context clearly indicates otherwise: DI=deionized; μm=micron; °C=degrees Centigrade; nm=nanometer; and ppm=parts per million. “Alkyl” refers to linear, branched and cyclic alkyl. The term “solvent-soluble” refers to a compound having a solubility of at least about 1000 ppm in the solvent. “Halide” refers to fluoride, chloride, bromide and iodide. The term “optoelectronic” refers to devices or materials useful in applications in which both photons and electrons are purposefully utilized. As used throughout this specification, “vaporizing” includes vaporizing, atomizing, nebulizing, misting and the like. Vaporizing refers to the technique of providing a stream or spray of very fine solution droplets.

All percentages are by weight and all ratios are by weight. All numerical ranges are inclusive and combinable.

The present invention provides a method of preparing substantially homogeneous composite materials having very low coefficients of thermal expansion. Preferably, such composite materials have substantially zero coefficients of thermal expansion, and more preferably zero coefficients of thermal expansion. By “very low coefficient of thermal expansion” is meant a coefficient of thermal expansion in the range of −3 to 3 ppm/° C. By “substantially zero coefficient of thermal expansion” is meant a coefficient of thermal expansion in the range of −1 to 1 ppm/° C.

Composite materials having very low coefficients of thermal expansion according to the present invention are prepared by the process including the steps of a) providing a first solution including one or more zirconium compounds in a solvent; b) providing a second solution including one or more tungsten compounds in a solvent; c) simultaneously vaporizing the first and second solutions; d) depositing on the surface of the substrate a composite having a very low coefficient of thermal expansion by spray pyrolysis or combustion chemical vapor deposition; wherein the composite is substantially homogeneous. Such composites preferably have substantially zero coefficients of thermal expansion.

The first solution useful in the present invention contains one or more solvent-soluble zirconium compounds in one or more solvents. Any solvent-soluble zirconium compound may be used, such as, but not limited to, zirconium halides, zirconium oxy halides, zirconium tetraalkoxylates, cyclopentadienyl zirconium halides, cyclopentadienyl zirconium dihalides, ziconium sulfate, zirconium hydroxide, zirconium nitrate, zirconium oxy nitrate, zirconium carboxylates such as zirconium acetate or zirconium acetylacetonate, and the like. The alkyl or alkoxylate groups may optionally be substituted. By substituted alkyl or alkoxylate is meant that one or more hydrogens of the alkyl or alkoxylate group is replaced with another substituent group, such as halo, cyano, and the like. Suitable zirconium compounds include, but are not limited to, one or more of: ZrO(NO₃)₂, ZrOCl₂, ZrOBr₂, ZrCl₄, ZrF₄, Zr(OH)₄, Zr(NO₃)₄, Zr(SO₄)₂, Zr(O(CH₂)₃CH₃)₄, Zr(OC(CH₃)₃)₄, Zr(OC₂H₅)₄, Zr(CF₃COCHCOCF₃)₄, Zr(OCH(CH₃)₂)₄, Zr(CH₃COCHCOCH₃)₄, Zr(O(CH₂)₂CH₃)₄, Zr(C₅H₄O₂F₃)₄, (C₅H₅)ZrCl₂, (C₅H₅)ZrHCl, Zr₃(C₆H₅O₇)₄ and mixtures thereof. Such zirconium compounds are generally commercially available or may be prepared by methods known in the literature.

Typically, the zirconium compound is present in the first solution in an amount of about 10% or less by weight, based on the total weight of the first solution, preferably about 5% or less by weight, and more preferably about 3% or less by weight. It will be appreciated by those skilled in the art that solutions containing greater than about 10% by weight solvent-soluble zirconium compound may be used.

The second solution useful in the present invention contains one or more solvent-soluble tungsten compounds in one or more solvents. Any solvent-soluble tungsten compound may be used, such as, but not limited to, tungsten halides, tungsten oxy halides, tungsten oxy hydrides, tungsten hexaalkoxylates, cyclopentadienyl tungsten halides, dicyclopentadienyl tungsten dihalides, tungsten amino complexes, tungsten ammonia complexes, tungsten nitrate, trialkoxy tungsten dihalides, tungsten carboxylates such as tungsten acetate or tungsten acetylacetonate, and the like. The alkyl or alkoxylate groups may optionally be substituted. By substituted alkyl or alkoxylate is meant that one or more hydrogens of the alkyl or alkoxylate group is replaced with another substituent group, such as halo, cyano, and the like. Suitable tungsten compounds include, but are not limited to, one or more of: WO₂Cl₂, H₂W₄O₁₂, H₂WO₄, (NH₄)₂WO₄, WBr₅, WCl₅, WCl₂(OC₂H₅)₃, W(OC₂H₅)₆, W(OCH(CH₃)₂)₆, (C₅H₅)₂WCl₂ and mixtures thereof. Such tungsten compounds are generally commercially available or may be prepared by methods known in the literature.

Typically, the tungsten compound is present in the second solution in an amount of about 10% or less by weight, based on the total weight of the first solution, preferably about 5% or less by weight, and more preferably about 3% or less by weight. It will be appreciated by those skilled in the art that solutions containing greater than about 10% by weight solvent-soluble tungsten compound may be used.

Any solvent capable of dissolving the solvent-soluble zirconium compounds is useful as the solvent in the first solution of the present invention. Likewise, any solvent capable of dissolving the solvent-soluble tungsten compound is suitable for use in the second solution of the present invention. Suitable solvents include water such as DI water, organic solvent and water-organic solvent mixtures. More than one organic solvent may be used in the first and second solutions of the present invention. A wide variety of organic solvents may be used to prepare the first and second solutions of the present invention. For example, alkanes such as (C₅-C₁₂)alkanes, alcohols such as (C₁-C₁₆)alkanols, esters, ketones, glycols, glycol ethers, aromatic hydrocarbons such as (C₁-C₈)alkylbenzenes, (C₁-C₈)alkoxybenzenes, di(C₁-C₈)alkylbenzenes, tri(C₁-C₈)alkylbenzenes, heterocyclic compounds such as cyclic ethers, lactones, lactams and heteroaromatic compounds, carbonates such as propylene carbonate, and the like. Suitable solvents include, but are not limited to: ethyl lactate, ethyl acetate, butyl acetate, ethyl butyrate, ethyl hexanoate, γ-butyrolactone, benzene, toluene, xylene, anisole, ethanol, iso-propanol, n-propanol, n-butanol, tert-butanol, tetrahydrofuran, pyridine, pyrrolidine, morpholine, acetone, ethylene glycol, diethylene glycol, polyethylene glycol, propylene glycol, dipropylene glycol, polypropylene glycol, propylene glycol monomethyl ether, propylene glycol dimethyl ether, diethylene glycol monomethyl ether, diethylene glycol diethyl ether, propylene glycol methyl ether acetate, and mixtures thereof. Particularly suitable is a mixture of ethanol and 2-ethyl hexanoate.

Dispersants or surfactants may be used in the solutions to keep the compounds from agglomerating or precipitating.

Either the first solution or the second solution or both may contain one or more additional solvent-soluble metal compounds. When the first solution contains an additional solvent-soluble metal compound, it is preferred that the additional metal compound is a tungsten compound or a yttrium compound, and more preferably a yttrium compound. When the second solution contains an additional solvent-soluble metal compound, it is preferred that the additional metal compound is a zirconium compound. It is preferred that the first solution further includes one or more yttrium compounds and the second solution further includes one or more zirconium compounds. While a wide variety of solvent soluble yttrium compounds may be used in the present invention, yttrium nitrate and yttrium acetylacetonate are preferred. When two or more metal compounds are used to prepare a solution, it is further preferred that the metal compounds have the same counterion. For example, if a zirconium and yttrium solution is prepared using zirconium nitrate, it is preferred that the yttrium compound is yttrium nitrate.

The first and second solutions of the present invention are prepared by dissolving the appropriate metal compound, i.e. zirconium or tungsten compound, in the desired solvent or solvent mixture. The solvent used to prepare the first solution may be the same or different from the solvent used to prepare the second solution.

In the process of the present invention, composites having very low coefficients of thermal expansion are prepared using either combustion chemical vapor deposition (“CCVD”) or spray pyrolysis. CCVD is preferred.

In spray pyrolysis, a film, typically a thin film, is formed by spraying a solution onto a heated substrate. The resulting film may subsequently receive additional heat treatment to form the desired phase. In such spray pyrolysis techniques, the substrate may be heated at a wide variety of temperatures, including at temperatures high enough so that subsequent heat treatment is not needed. The substrate may be heated using any means, such as a hot plate, flame, or other heat source. Typically, a flame is not used in spray pyrolysis. Such spray pyrolysis techniques are well known to those skilled in the art.

Thus, when spray pyrolysis is used, the present invention provides a method for depositing composites having very low coefficients of thermal expansion on a substrate including the steps of a) providing a first solution including one or more zirconium compounds in a solvent; b) providing a second solution including one or more tungsten compounds in a solvent; c) simultaneously vaporizing the first and second solutions; d) heating in a pyrolysis zone a substrate having a surface to be coated; e) depositing on the surface of the substrate a composite having a very low coefficient of thermal expansion; wherein the composite is substantially homogeneous.

CCVD is the vapor deposition of a film onto a substrate in or near a flame which causes the reagents fed into the flame to chemically react. Such substrate does not need to be heated. Flammable solvents containing elemental constituents of the desired coating in solution as dissolved reagents are sprayed through a nozzle and burned. Alternatively, vapor reagents can be fed into the flame and burned. Non-flammable solvents may also be used with a gas fueled flame. An oxidant, such as oxygen, is provided at the nozzle to react with the solvent during burning. Air is the typical source of oxygen. Upon burning, reagent species present in the flame chemically react and vaporize, and then deposit and form a coating on a substrate held in the combustion gases or just beyond the flame's end. No furnace, auxiliary heating or reaction chamber is necessary for CCVD. CCVD is typically performed under ambient conditions and in the open atmosphere. The temperature of the flame may be controlled by the ratio of fuel to oxygen or air. Suitable CCVD process is disclosed in U.S. Pat. No. 6,013,318 (Hunt et al.).

When CCVD is used, the present invention provides a method for depositing composites having very low coefficients of thermal expansion on a substrate including the steps of a) providing a first solution including one or more zirconium compounds in a solvent; b) providing a second solution including one or more tungsten compounds in a solvent; c) simultaneously combusting the first and second solutions to form a vapor phase composite; d) depositing on the surface of the substrate a composite having a very low coefficient of thermal expansion; wherein the composite is substantially homogeneous. Such CCVD process may be used over a wide range of flame temperatures, deposition zone pressures or temperatures, or substrate temperatures.

In either spray pyrolysis or CCVD, the solutions are vaporized by passing the solutions through a nozzle, atomizer, nebulizer or the like. Suitable nebulizers include a needle bisecting a thin high velocity air stream forming a spray. During CCVD, such spray is ignited. The solutions may be mixed with a fuel source, such as propane or organic solvents, prior to being vaporized.

One nozzle may be in either the spray pyrolysis or CCVD process of the present invention by feeding both solutions to the nozzle. The solutions are then combined prior to or at the nozzle and the combined solutions are vaporized. It is preferred that two nozzles be used with either the spray pyrolysis or CCVD processes according to the present invention. The use of two nozzles allows for the simultaneous deposition of appropriate proportions of NTE and PTE materials to provide a composite having a very low coefficient of thermal expansion.

When two nozzles are used, two vapor streams are produced, one from the first solution and one from the second solution. The two vapor streams may be combined prior to contacting the substrate or may be intermixed on the surface of the substrate. When spray pyrolysis is used, the vapor streams are intermixed upon delivery to the substrate surface. In CCVD, it is preferred that the two vapor streams are combined after combustion but prior to delivery to the substrate surface.

The substrates upon which the composites of the present invention may be deposited include, but are not limited to, metal, ceramic, inorganic or organic material, or the like.

A wide variety of composites having very low or substantially zero coefficients of thermal expansion may be prepared according to the present invention. A particularly suitable composite includes ZrW₂O₈ and (Y,Zr)O₂. For example, a solution of zirconium and tungsten compounds are sprayed from a nozzle and pyrolyzed to form ZrW₂O₈ and simultaneously a solution of zirconium and yttrium compounds are sprayed from a separate nozzle and pyrolyzed to form (Y,Zr)O₂₋ₓ. The relative amounts of material produced are tailored such that composites with zero or very small thermal expansion coefficients result. The process may be accomplished by two-nozzle spray pyrolysis, CCVD, aerosol decomposition, spray roasting, evaporative decomposition, spray calcination, or similar techniques, and preferably by CCVD. By spraying the materials simultaneously, a homogeneous composite is formed without the need for blending, sintering, or other complicated processing. Such composite may be collected on a substrate and isolated as a monolithic ceramic composite.

The composites prepared according to the present invention provides have very low coefficients of thermal expansion and are substantially homogeneous mixtures of one or more negative coefficient of thermal expansion materials and one or more positive coefficient of thermal expansion materials. Such substantially homogeneous mixtures of these materials have heretofore not been achieved by conventional methods. The present invention provides composites having improved stability and uniformity. Such composites are comprised of nanocrystalline particles are thus less susceptible to fatigue than are composites prepared by known methods.

The present invention can also be used to prepare a composite having intimately-mixed particles of materials, the composite having very low coefficients of thermal expansion including the steps of a) providing a first solution including one or more zirconium compounds in a solvent; b) providing a second solution including one or more tungsten compounds in a solvent; c) simultaneously combusting the first and second solutions to form vapor phase composite particles; and d) isolating the composite particles; wherein the composite particles are substantially homogeneous. In such process, the first and second solutions are combusted to form two vapor streams which are then combined to form the desired composite. Thus, it is preferred that two nozzles be used. Particles of composite may then be collected, such as by passing the vapor stream through a water curtain or air curtain, or by depositing the composite particles on a filter, or by other suitable collection media. Such composites are substantially homogeneous and such composite particles typically are nanometer-sized. Such composite particles typically have a particle size of about 50 nm or less, preferably about 30 nm or less, and more preferably about 20 nm or less. Such composite particles are suitable for blending, such as homogeneous blending, with organic or inorganic materials. Particularly suitable blends include the composite particles described above with one or more polymers. Suitable polymers include, but are not limited to, cyclic olefin copolymers, liquid crystal polymers, polysulfones, PEEK (“polyetheretherketone”), cyclic olefin copolymers, polyester carbonates, polyimides, epoxies and other high use temperature polymers.

The present invention can also be used to isolate nanometer-sized particles of NTE material. Such particles typically have a particle size of about 50 nm or less, preferably about 30 nm or less, and more preferably about 20 nm or less. Thus, particles of materials having negative coefficients of thermal expansion may be prepared by the method including the steps of a) providing a solution including one or more tungsten compounds and one or more zirconium compounds in a solvent; b) vaporizing the solution to form vapor phase particles; and d) isolating the particles. Such NTE particles are preferably prepared by CCVD. The particles may be isolated as described above. Such NTE material is substantially homogeneous. Only one nozzle need be used to prepare and isolate NTE particles, however, two nozzles may be used if two solutions are prepared. Suitable NTE material that can be advantageously prepared according to the present invention includes ZrW₂O₈.

For example, a solution of Zr and W compounds can be sprayed from a nozzle and pyrolyzed to form ZrW₂O₈. The particles can be collected as a powder by spraying them into a curtain of water, onto a filter, or into another collection system. These particles can then be dispersed in one or more polymers form blends having a modified response to temperature. Suitable polymers include, but are not limited to; cyclic olefin copolymers, liquid crystal polymers, polysulfones, PEEK, cyclic olefin copolymers, polyester carbonates, polyimides, epoxies and other high use temperature polymers. The process may be accomplished by single-nozzle spray pyrolysis, CCVD, aerosol decomposition, spray roasting, evaporative decomposition, spray calcination, or similar techniques, and preferably by CCVD. By using nanometer-sized particles, homogeneous composites with organic materials can be fabricated.

Dispersants or surfactants or other compatiblizing compounds may be used with the isolated particles to prevent or reduce agglomeration of the particles. Such dispersants or surfactants may also aid in the fabrication of polymer-composite blends.

The present invention provides a device including one or more composites having very low or negative coefficients of thermal expansion. Devices include electronic devices, optoelectronic devices, optical devices and the like. Suitable devices include, but are not limited to: heat sinks, printed wiring boards, hard disk drive heads, wafer boats, wafer carriers, rapid thermal processing equipment, micro-machine alignment, lithography masks, lenses, fiber optic gratings, fiber optic cable reinforcement, wavelength division multiplexers, optical connectors, mirrors as well as other optical components. Such devices may further include one or more polymeric materials, such as, but not limited to, cyclic olefin homopolymers and cyclic olefin copolymers.

Materials with negative thermal expansion and composites with zero thermal expansion are useful in a number of applications, such as in the packaging of electronic and optoelectronic components. Low or zero coefficient of thermal expansion (“CTE”) materials are useful as innerlayer dielectrics and as adhesives, such as for bonding electronic and optoelectronic components. Such materials are also useful where materials of disparate thermal expansion need to be conjoined, such as, but not limited to: heat sinks, printed wiring boards, lamination adhesives, underfill, and similar applications. They may also be used in hard disk drive heads, wafer boats, wafer carriers, rapid thermal processing equipment, micro-machine alignment, and lithography masks. In optical and optoelectronic applications, such materials may be useful in the fabrication of lenses, fiber optic gratings, fiber optic cable reinforcement, wavelength division multiplexers, optical connectors, mirrors as well as other optical components.

The negative thermal expansion and zero thermal expansion composites are useful as dielectric materials. Such composite materials may be combined or blended with other inorganic or organic dielectric materials, such as, but not limited to, epoxies, polyimides, polyarylene ethers, organo polysilicas, silsesquioxanes and the like. Particularly useful applications of these composites is in dielectric layers used in the fabrication of electronic substrates for packaging or in as dielectric material used in printed wiring board manufacture. For example the CTE of a dielectric resin is about 60 ppm/° C. By incorporating about 30-70% of NTE powders into dielectric resin, the CTE can be reduced to about 20 ppm/° C. which is the CTE of a common substrate laminate material, FR4, used in the electronics industry. Thus, the present invention also provides a printed wiring board substrate including a dielectric layer including one or more negative thermal expansion or very low coefficient of thermal expansion composites. Particularly suitable dielectrics used in the manufacture of printed wiring boards include, but are not limited to, epoxy, glass reinforced epoxy or polyimide.

Another particularly useful application of these composites having negative coefficients of thermal expansion is in adhesives. Thus, adhesives may include one or more NTE composites. Particularly suitable adhesives include one or more NTE composites and epoxy. Such adhesives are useful for attaching electronic and optoelectronic components. NTE materials are used in sufficient volume to counter the PTE of the epoxy resulting in a zero CTE adhesive. Such adhesives will not expand or contract thereby improving lifetime of attachment of electronic components and optoelectronic components such as single mode fibers and lasers.

The composites of the present invention may also be used in molding ferrules for optical fiber connectors. The ferrules secure single mode fibers in place to an accuracy greater than 1 μm. Currently zirconium based materials are used for ferrules. The ferrules may be prepared by combining the NTE materials of the present invention with injection moldable plastics. Suitable plastics include, but are not limited to: liquid crystal polymers, polysulfones, PEEK, cyclic olefin copolymers, polyester carbonates, polyimides and other high use temperature polymers.

A still further use of the composites of the present invention is in the fabrication of V-groove substrates for aligning single mode fibers to optoelectronic components. Here a fiber is secured to a composite substrate which has zero thermal expansion. Optical alignment is thus ensured with a passive technology, rather than an active one that must adjust to movement induced by changing temperature.

Yet another use of composites of the present invention is in optical articles where changes of refractive indices and physical dimensions are not desirable. For example high precision lenses should not change their imaging properties with temperature. For that reason glassy materials are often used. However it is difficult to mold and grind glass lenses. A preferred approach is to use an optically clear plastic with a PTE and incorporate NTE materials to make a zero CTE plastic material which can be injection molded. Injection molding allows the formation of complex surfaces (such as diffractive lens surfaces), and it is relatively easy to produce lenses at low cost. Preferred optical plastics are acrylates, methacrylates, polycarbonates, polystyrenes and cyclic olefin copolymers.

Another example of an optical application is a wave division multiplexing (“WDM”) device. WDM devices have gratings in filter stacks, optical fibers or optical integrated circuits, and can combine or separate out wavelengths in high bandwidth communication systems. WDM devices are extremely sensitive to changes in refractive indices caused by temperature and environmental changes (e.g., humidity). At present WDM devices are temperature stabilized with additional external devices and hermetically packaged, thereby adding to the complexity and cost. NTE materials can be used as substrates for WDM devices made from PTE glasses. The substrate can balance and cancel the expansion of the WDM device. Another embodiment is to use optically transparent composites of NTE and PTE materials to fabricate the WDM device. The PTE material could be glass, polymer or an organic inorganic sol gel type material.

The following examples are intended to illustrate further various aspects of the present invention, but are not intended to limit the scope of the invention in any aspect.

### EXAMPLE 1

A composite of ZrW₂O₈ and (Y,Zr)O₂ is fabricated as follows. A solution of Zr(OC₂H₅)₄ and W(OC₂H₅)₆ in ethanol is prepared such that the metal ratio is 1:2 (Zr:W). A separate solution of yttrium acetylacetonate and zirconium acetylacetonate is prepared with the metal ratio about 1:19 (Y:Zr).

Using a combustion chemical vapor deposition process, such as that disclosed in U.S. Pat. No. 6,013,318 (Hunt et al.), oxygen-enriched air is used as a propellant gas to push the solution through a nozzle. The mixture is combusted as it leaves the nozzle and produces nanometer-sized particles of the oxide materials. Two separate nozzles are used, one for each solution. The flow patterns of the two nozzles intersect, such that an intimate mixture of the two particles is formed at the collection substrate to produce a uniform composite. The solutions are fed to the combustion chemical vapor deposition apparatus at a rate and in an amount such that composites with very low thermal expansion coefficients are formed.

### EXAMPLE 2

A dilute aqueous solution of zirconyl nitrate and tungstic acid is prepared such that the metal ratio is 1:2 (Zr:W). Separately, a solution of zirconyl nitrate and yttrium nitrate is prepared. Each solution is passed through a separate nebulizer and hot zone, such that the solution droplets are pyrolyzed to form ZrW₂O₈ and (Y,Zr)O₂ particle streams, respectively. The separately-nebulized solutions may be passed through the same furnace, if concentrations are sufficiently dilute such that the droplets do not coalesce before pyrolysis. The particle streams are then combined such that a composite is formed from the mixture of fine particles. The solution concentrations are adjusted to ensure the production of nanometer-sized oxide particles. The resulting composites have very low thermal expansion coefficients.

### EXAMPLE 3

Nanometer-sized particles of ZrW₂O₈ are fabricated as follows. A solution of Zr(OC₂H₅)₄ and W(OC₂H₅)₆ in ethanol is prepared such that the metal ratio is 1:2 (Zr:W). Using a combustion chemical vapor deposition process, such as that disclosed in U.S. Pat. No. 6,013,318 (Hunt et al.), oxygen-enriched air is used as a propellant gas to push the solution through an atomization nozzle. The mixture is combusted as it leaves the atomization nozzle to produce nanometer-sized particles of the desired oxide. These particles are then collected on a ceramic filter.

### EXAMPLE 4

Nanometer-sized particles of ZrW₂O₈ are fabricated as follows. A dilute aqueous solution of zirconyl nitrate and tungstic acid is prepared such that the metal ratio is 1:2 (Zr:W). Using a spray pyrolysis process analogous to Example 2, the mixture is sprayed through an atomization nozzle and heated to produce nanometer-sized particles of the oxide. These particles are collected on a ceramic filter.

### EXAMPLE 5

The compounding of nanoparticles in an optical polymer matrix is performed as follows. Nanometer-sized particles of a NTE material described above are compounded with a cyclic olefin copolymer, Topas 6013 (Celanese, Ticona, Summit, N.J.,) in an appropriate weight fraction. Dispersants, surfactants or other compatibilizing agents are used to facilitate the formation of a homogeneous polymer-inorganic composite. The mixture is then extruded, for example, with a Leistritz twin screw extruder(Model MC 18 GG/GL available from American Leistritz Extruder Corp., Sommerville, N.J.). The barrel temperature is about 230° C. The compounding is at about 100 rpm. The extrudate is molded into tensile bars in an Arburg All Rounder (Model 220M, available from Polymer Machinary, Berlin, Conn).

1-13. (canceled)

14. A composite having a very low coefficient of thermal expansion wherein the composite comprises a substantially homogeneous mixture of one or more negative coefficient of thermal expansion materials and one or more positive coefficient of thermal expansion materials, and wherein the composite comprises zirconium and tungsten.

15. The composite of claim 14 comprising ZrW₂O₈ and (Y,Zr)O₂.

16-25. (canceled)

26. A device comprising one or more composites of claim 14.

27. The device of claim 26 wherein the device is chosen from heat sinks, printed wiring boards, hard disk drive heads, wafer boats, wafer carriers, rapid thermal processing equipment, micro-machine alignment, lithography masks, lenses, fiber optic gratings, fiber optic cable reinforcement, wavelength division multiplexers, optical connectors, and mirrors.

28. (canceled)

29. The composition of claim 30 wherein the polymer is a cyclic olefin homopolymer or copolymer.

30. A composition comprising one or more polymers and one or more composites of claim 14.

31. An adhesive comprising one or more negative coefficient of thermal expansion composites.

32. The adhesive of claim 31 further comprising epoxy.

33. The composite of claim 14 in the form of particles having a particle size of 50 nm or less.
